(19) United States
(12) Patent Application Publication
(10) Pub. No.: US 2014/0008498 A1
(43) Pub. Date: Jan. 9, 2014

(54) Tilt Wing Rotor VTOL

(71) Applicant: Johannes Reiter, Laakirchen (AT)

(72) Inventor: Johannes Reiter, Laakirchen (AT)

(21) Appl. No.: 13/824,363

(22) PCT Filed: Sep. 16, 2011
(86) PCT No.: PCT/EP11/66143

§ 371 Date: Apr. 29, 2013

(30) Foreign Application Priority Data
Sep. 17, 2010 (EP) 10177492.5
Dec. 2, 2010 (EP) 10193555.9

(51) Int. Cl. B64C 29/00

(52) U.S. Cl. CPC B64C 29/00
USPC 244/7 A; 244/99.11

(57) ABSTRACT

An aircraft for vertical take-off and landing. The aircraft comprises a first wing, a second wing and a fuselage. The first wing comprises a first longitudinal wing axis and the second wing comprises a second longitudinal wing axis. The first wing extends along the first longitudinal wing axis and the second wing extends along the second longitudinal wing axis from the fuselage. The first wing is tiltable with a first rotational direction around the first longitudinal wing axis and the second wing is tiltable with a second rotational direction around the second longitudinal wing axis. In a fixed-wing flight mode, the wings do not rotate around a second axis. In a hover flight mode, the wings are tilted around the longitudinal wing axis with respect to its orientation in the fixed-wing flight mode and that the wing rotates around the second axis.

### TECHNICAL FIELD

The present invention relates to a wing for a vertical take-off and landing aircraft and to a fuselage for a vertical take-off and landing aircraft. Moreover, the present invention relates to an aircraft for vertical take-off and landing comprising the wing and the fuselage. Furthermore, the present invention relates to a method of controlling an aircraft for vertical take-off and landing and to a method of producing an aircraft for vertical take-off and landing.

### BACKGROUND

It is an aim to have aircrafts that are able to start and land without a runaway for example. Hence, in the past several developments for so called Vertical Take-Off and Landing aircrafts (VTOL) have been done. Conventional VTOL-Aircrafts need a vertical thrust for generating the vertical lift. Extreme thrust for vertical take-off may be produced by big propellers or jet engines. Propellers may have the disadvantage in travel flight of an aircraft due to a high drag.

Moreover, if a VTOL-Aircraft is configured as a fixed-wing aircraft, the main wings may disturb the airflow in a hover flight, so that a need for even more thrust is necessary. Additionally, the steering is very complex.

An exemplary concept for VTOL-Aircrafts that became reality is the “Harrier” or the “F-35 Lightning II”. Both concepts are very inefficient due to the need of complex control systems and the high kerosene consumption.

An efficient solution for a hover flight capable aircraft is performed by helicopters, using e.g. a big wing area. In a known system, an aircraft comprises an engine for vertical lifting the aircraft (e.g. a propeller) and a further engine for generating the accelerating the aircraft in the travel mode up to a desired travelling speed. Depending on the intended speed, there can be used jet or propeller engines.

### SUMMARY

It may be an object of the present invention to provide a more efficient vertical take-off and landing aircraft.

This object may be met by the subject matter according to the independent claims. Advantageous embodiments of the present invention are described by the dependent claims.

According to a first aspect of the present invention, a wing for a vertical take-off and landing aircraft is presented. The wing is mountable to a fuselage such that the wing is tiltable around a longitudinal wing axis of the wing and such that the wing is rotatable around a second axis which differs to the longitudinal wing axis. The wing is adapted in such a way that in a fixed-wing flight mode, the wing does not rotate around the second axis. The wing is further adapted in such a way that in a hover flight mode the wing is tilted around the longitudinal wing axis with respect to its orientation in the fixed-wing flight mode and that the wing rotates around the second axis.

According to a further exemplary embodiment a fuselage for a vertical take-off and landing aircraft is presented. The fuselage is adapted in such a way that the above-described wing is mountable to the fuselage. According to a further aspect of the present invention, an aircraft for vertical take-off and landing is presented. The aircraft comprises a first wing according to the above-described wing and a second wing according to the above-described wing. Moreover, the aircraft comprises a fuselage as described above. The first wing comprises a first wing longitudinal axis and the second wing comprises a second wing longitudinal axis, wherein the first wing extends along the first wing longitudinal axis and the second wing extends along the second wing longitudinal axis from the fuselage. The first wing is tiltable with a first rotational direction around the first wing longitudinal axis and the second wing is tiltable with the second rotational direction around the second wing longitudinal axis.

In a further exemplary embodiment, the aircraft may comprise a third wing or more wings. The third or more wings may be retractable for example. In the fixed-wing mode, the wings may form a double-decker, for example. The wings may rotate around the second axis clockwise or counter-clockwise.

According to a further aspect of the present invention, a method of controlling an aircraft for vertical take-off and landing is presented. The method comprises the converting the aircraft in a fixed-wing flight mode by arranging the wing and the fuselage with respect to each other such that a fixed-wing flight is enabled. Moreover, the method comprises a converting of the aircraft in a hover flight mode by tilting the wing around a longitudinal wing axis and by rotating the wing around a second axis for enabling a hover flight.

According to a further aspect of the present invention a method of producing an aircraft for vertical take-off and landing is presented. The method comprises a mounting of a wing to a fuselage such that the wing is rotatable around a second axis of the fuselage. Moreover, the present method comprises a mounting of the wing to the fuselage such that the wing is tiltable around a longitudinal wing axis of the wing.

In the fixed-wing flight mode, the wing is fixed to the fuselage without having a relative motion between the wing and the fuselage, so that by a forward motion of the aircraft the lift is generated by the wing, which is moved through the air. In the hover flight mode, the wing is rotating around the second axis, so that due to the rotation of the wing through the air a lift is generated even without a relative movement of the aircraft through the air. Hence, by rotating the wing through the air, a hover flight mode is achievable, e.g. such as a helicopter. The fuselage may be rotatable together with the wing around the second axis. Alternatively, the wing may be rotatable with respect to the fuselage, so that only the wing rotates in the hover flight mode for generating lift. Moreover, if the wings rotate in the hover flight mode, a stabilizing moment (e.g. a gyroscopic moment, i.e. a conservation of angular momentum) for stabilizing the aircraft is generated.

Hence, by the present invention, a vertical take-off and landing aircraft is presented which combines the concept of a fixed-wing flight mode aircraft and a hover flight mode aircraft. Hence, both advantages of each flight mode may be combined. For example, a fixed-wing flight aircraft is more efficient during the cruise flight, i.e. when the aircraft moves through the air. On the other side, in the hover flight mode of the aircraft, the wing rotates such as wings or blades of a helicopter, so that the wing itself generates the lifting force in the hover flight mode. This is more efficient due to the large wing length in comparison to lift generating propulsion engines in known VTOL aircrafts. For example, known VTOL aircrafts generates the lift by engine power and by the aerodynamic lift of the rotation of the wing.

The wing comprises a longitudinal wing axis, wherein the longitudinal wing axis is the axis that connects for example the wing root with the wing tip. With the wing root, the wing is mountable for example to the fuselage, wherein the wing tip defines a free end of the wing. The longitudinal wing axis may be parallel e.g. with a leading edge or a trailing edge of the wing. Moreover, the longitudinal wing axis may be an axis that is approximately perpendicular to the fuselage longitudinal axis. The wing may comprise an aerodynamical wing profile comprising a leading edge to which the air attacks and a trailing edge from which the air streams away from the wing.

The above-described aircraft may comprise a first wing and a second wing, wherein each wing is connected with its root end to the fuselage of the aircraft. Each of the first wing and the second wing comprises an individual and separated first longitudinal wing axis and second longitudinal wing axis. In the hover flight mode, the first longitudinal wing axis and the second longitudinal wing axis are oriented substantially parallel. In the fixed-wing flight mode, the first longitudinal wing axis and the second longitudinal wing axis may also extend parallel to each other. In an alternative embodiment the first longitudinal wing axis and the second longitudinal wing axis may run unparallel between each other, so that an angle between the first longitudinal wing axis and the second longitudinal wing axis is provided. If the first longitudinal wing axis and the second longitudinal wing axis comprise an angle between each other, the first wing and the second wing may comprise a wing sweep, in particular a forward swept, a swept, an oblique wing or a variable swept (swing wing).

Moreover, the wing may comprise control surfaces, such as an aileron, for example.

The aircraft according to the present invention may be a manned aircraft or an unmanned aircraft vehicle (UAV). The aircraft may be e.g. a drone that comprises for example a wing span of approximately 1 m to 4 m (meter) with a weight of approximately 4 kg to 6 kg (kilograms).

The fuselage describes the main body of the aircraft, wherein in general the centre of gravity of the aircraft is located in the area of the fuselage. The fuselage may be according to the present invention a small body to which the wing is mounted, so that the aircraft may be defined as a so-called flying wing aircraft. In particular, the fuselage may be a section of the wing and the fuselage may comprise a width equal to the chord line (e.g. a width) of the wing. Alternatively, the fuselage comprises a length that is longer than e.g. the chord line (e.g. the width) of the wing that connects the leading edge and the trailing edge. The fuselage comprises a nose and a tail section.

The second axis may be in an exemplary embodiment the longitudinal fuselage axis of the fuselage. In an exemplary embodiment, the second axis may comprise an angle between the longitudinal fuselage axis and may thus run unparallel to the longitudinal fuselage axis.

The wing may be fixed to the fuselage such that the wing is not rotatable relative to the fuselage around the second axis. Hence, in the hover flight mode, both, the wing and the fuselage rotate around the second axis for generating lift. In particular, in the hover flight mode, the wing and the fuselage rotate together around the second axis for generating lift. In an alternative embodiment, the wing is mounted to the fuselage such that the wing rotates around the second axis relatively to the fuselage, so that in the hover flight mode the wing may rotate for generating lift and the fuselage may not rotate around the second axis. Additionally, along the longitudinal fuselage axis, a further wing may be attached to the fuselage.

According to a further exemplary embodiment, the wing comprises a bearing ring and/or a supporting ring, wherein the bearing ring/supporting ring is formed for being clamped to a surface of the fuselage for mounting the wing to the fuselage.

When generating a rotation of the wing around the fuselage, it is a need that the parts of the wing surround the fuselage and do not run through the fuselage, e.g. for fixing purposes. The wing is rotatably fixed to the circumferential surface of the fuselage. In particular, it is necessary to form a movable, e.g. sliding, connection between the wing and the surface of the fuselage. Such a movable connection may be achieved by using the bearing ring and/or the supporting ring. The bearing ring may be a closed or open ring for being fixed to the wing. The bearing ring is slideably clamped to the outer surface of the fuselage, wherein between the bearing ring and the fuselage a slide bearing is formed. Besides the slide bearing, the bearing ring and the outer surface of the fuselage may be adapted to form e.g. a ball bearing, so that abrasion is reduced. The bearing ring may be slidable with respect to the supporting ring, wherein the supporting ring is fixed to the fuselage without being slidable.

According to a further exemplary embodiment, the bearing ring is slideably mountable to the fuselage for being slideable along the surface of the fuselage in a direction of the second axis. The wing comprises a first bolt and a second bolt. The wing is mountable to the fuselage by the first bolt and the wing is mounted to the bearing ring by the second bolt such that by a predetermined movement of the bearing ring along the second axis the wing is tiltable between the fixed-wing flight mode and the hover flight mode.

The present exemplary embodiment describes a robust mechanical system for switching the wing between the fixed-wing flight mode and the hover flight mode. The first bolt is mounted to the wing and to the fuselage. The wing may be rotatable around the first bolt. Moreover, the first bolt is as well rotatable around the fuselage. The second bolt is fixed to the bearing ring and the wing, wherein the second bolt is rotatable with respect to the wing and the bearing ring. Hence, if the first bolt and the second bolt are fixed to spaced locations at the wing, a relative movement of the first bolt with respect to the second bolt causes a tilting of the wing around the longitudinal wing axis. Hence, by moving the bearing ring along the second axis (longitudinal fuselage axis), the first bolt and the second bolt move relative to each other due to the different fixing point around a common centre of rotation, so that the wing is tiltable. By the bolt fixing of the wing to the fuselage, an adjustable but also robust mechanical system is achieved.

According to a further exemplary embodiment, the wing comprises a servomotor. The wing may be connected by a bolt to the fuselage. The servomotor may control the tilting of the wing by turning the bolt for example.

According to a further exemplary embodiment, the bearing ring is slideably mountable to the fuselage for being slideable along the surface of the fuselage in the direction of the longitudinal fuselage axis (e.g. second axis). A guiding slot of the fuselage may be adapted for slideably engaging the first bolt of the wing. The fuselage is adapted for holding the bearing ring to which the wing is mounted with the second bolt, wherein the bearing ring is slideably mountable to the fuselage along the longitudinal fuselage axis. The guiding slot is formed in such a way that the second bolt is movable along a run of the guiding slot with a predetermined movement. Alternatively or additionally, a further guiding slot may be arranged in the bearing ring, so that the second bolt of the wing is engaged by the further guiding slot. The first bolt may be fixed directly and non-slidable to the fuselage or the first bolt may be fixed movable in the above described guiding slot of the fuselage.

For example, at a first end of the guiding slot, the wing is in a position for enabling the fixed-wing flight mode, wherein, if the first bolt is slid along the run of the guiding slot to a second end of the guiding slot, the wing is in a position for enabling the hover flight mode. In order to enforce the mechanical bolt-slot connection, the guiding slot may provide at the first end and at the opposed second end a respective second recess, wherein the first bolt may be clicked into the first or the second recess in order to create a robust mechanical connection. An unlatch mechanism may force the first bolt to leave the first recess or the second recess in order to change the wing position from the hover flight mode to the fixed-wing flight mode.

According to a further exemplary embodiment, the fuselage comprises an empennage for controlling the flight direction in the fixed-wing flight and the hover flight.

The empennage may comprise a horizontal tail and/or a vertical tail wherein each tail element may comprise a controllable control surface. Hence, in the fixed-wing flight mode, the air streaming over the empennage may be used to control the flight direction of the aircraft. Moreover, in the hover flight mode, the rotating wing may guide an air stream to the empennage, wherein the empennage may use the passing air in order to stabilize and control the aircraft in the hover flight mode.

The empennage may be arranged at the fuselage nose or the fuselage tail, for example.

In a further exemplary embodiment, the empennage is rotatably mounted to the fuselage such that the empennage is rotatable around the longitudinal fuselage axis in the hover flight modus for reducing a torque that is induced by the rotating wing in the fuselage. In particular, the rotation of the wing in the hover flight mode induces a torque to the fuselage, so that the fuselage itself may begin to rotate due to the rotation of the wing. Hence, by the rotation of the empennage a counter-torque may be generated in order to equalize the induced torque of the rotating wing. Thus, a rotation of the fuselage in the hover flight mode may be prevented.

According to a further exemplary embodiment of the aircraft, the first rotational direction of the first wing differs to the second rotational direction of the second wing. In particular, if the first wing extends from one side of the fuselage and the second wing extends from the opposed side of the fuselage, and the first wing and the second wing rotates around the longitudinal fuselage axis, it is necessary that the respective wing edges, i.e. the leading edges of the wings, are moved through the air, so that lift is generated by the wing profile. Hence, for the transformation of the aircraft from the fixed-wing flight modus to the hover flight modus, the first wing may rotate around its first wing longitudinal axis around 60° (degrees) to 120°, in particular approximately 90°, in a first rotational direction and the second wing may be tilted around 60° (degrees) to 120°, in particular approximately 90°, around the second wing longitudinal axis in a second rotational direction, which is an opposed direction with respect to the first rotational direction.

In an alternative embodiment it is as well possible that the first rotational direction and the second rotational direction are equal.

According to a further exemplary embodiment of the present invention, the aircraft comprises a propulsion system for generating thrust such that the aircraft is driven in the fixed-wing flight mode and/or the hover flight mode.

The propulsion system may comprise propeller engines, turboprop engines, rocket propulsion units and/or jet engines. Each of the propulsion devices of the propulsion system may be located and mounted to the fuselage or to the wing. To the fuselage and/or to each of the wings, one or a plurality of propulsion devices and/or propulsion units may be installed. Moreover, the propeller engines may be driven by electrical power or by fuel, such as hydrogen or kerosene. The necessary fuel tank or batteries may be installed in the fuselage or in the wing. Between the battery or the tank and the propulsion devices, a supply line system may be installed, so that in particular power or fuel may be directed from the fuel tank or the battery to the respective propulsion device. Hence, the batteries or the fuel tanks may be installed to desired locations spaced from the propulsion devices, so that a beneficial balance point adjustment of the aircraft may be achieved.

Moreover, the aircraft is designed for providing autorotation properties. Autorotation refers to a generation of lift by the wings, even when the aircraft is not being driven by the propulsion system. In particular, if a propulsion device fails, the aircraft is able to use an autorotation lift of the wing to slow its descent down and land in a controlled manner. For enabling the autorotation properties of the aircraft a control unit of the aircraft may control during the autorotation maneuver the lift generated by the autorotating wings and the airspeed of the aircraft. In particular, the control unit controls the tilting position (pitch) and/or the rotational speed of the wings, for example. The autorotation property depends on the maintenance of air velocity through the wings in the hover flight mode. During the autorotation maneuver the airspeed is provided by the aircraft's descent.

The propulsion devices of the propulsion system may be installed in an exemplary embodiment in the tail of the fuselage. In case that the propulsion device is a propeller or a turboprop, it may be beneficial to install the propulsion devices to the fuselage nose or to the wings.

According to a further exemplary embodiment, the aircraft comprises an air distribution system mounted inside the fuselage and inside the first wing and/or the second wing. The first wing and/or second wing comprise(s) at least a nozzle section for blowing out air such that thrust is generatable. Hence, a tip jet configuration is generated. The propulsion system comprises an air suction unit that is mounted to the aircraft such that air is sucked inside the fuselage and fed to the air distribution system. The air distribution system is arranged inside the wing and/or the second wing such that the fed air is guided to the nozzle sections.

By the present exemplary embodiment, the suction unit may be installed to a beneficial place with respect to the balance point of the aircraft. At the nozzle sections, where thrust is generated, it is only necessary to install very light and small nozzles to which compressed fed air may be guided by the air distribution system. For example, if the nozzle sections are located at the tip ends of the respective wing, the heavier air suction unit may be installed to the fuselage. No further heavy and complex installations have to be installed to the wings except of small holes that contains or form the nozzles. Hence, a very light and balanced propulsion system may be generated.

For example, the thrust that is generated by the nozzles may cause propulsion of the aircraft in the fixed-wing flight mode. In this mode, the direction of the thrust of the nozzle sections may be parallel and may comprise substantially the same thrust direction. In the hover flight mode, the wings are tilted in opposite direction, so that for example two nozzle sections, one installed at the left first wing and the other installed at the second right wing, generate thrust in opposite direction to each other. Thus, if for example thrust is generated at the tip end of the first wing in a first direction and at the opposed tip end of the second wing is generated in an opposed direction with respect to the first thrust direction at the first wing, a rotation of the first wing and the second wing around the longitudinal fuselage axis is generated. By the rotation, the hover flight mode is enabled.

In particular, no high masses have to be installed to the wings and to the tip end of the wings. Hence, the induced centrifugal force, caused by the rotation of the wings and the masses mounted to the wing may be reduced, so that better and lighter materials may be used.

According to a further exemplary embodiment, the first wing and/or the second wing comprises a plurality of nozzle sections connected to the air distribution system for blowing out the air such that thrust is generatable. Each of the plurality of nozzle sections is controllable in such a way that the thrust generated by each of the plurality of nozzle sections is adjustable individually. Hence, the thrust direction of each nozzle may be adjusted independently, so that the flight direction and the stabilization of the aircraft in the fixed-wing flight mode and the hover flight mode may be controlled and stabilized. In particular, in a transition status between the hover flight mode and the fixed-wing flight mode, it may be a position, in which the aircraft is still too slow, so that no tilt by the fixed wings is generated, and the rotation of the wings may be already too slow, so that not enough lift by the rotation of the wings is generated. Thus, in order to stabilize the aircraft in the transition status, the thrust direction of the nozzles may generate the stabilization of the aircraft till the rotation of the wings is high enough in the hover flight mode or till the speed of the aircraft through the air is fast enough for generating lift in the fixed-wing flight mode.

According to a further exemplary embodiment, the propulsion system comprises a first propulsion unit mounted to the first wing for generating first thrust and a second propulsion unit mounted to the second wing for generating second thrust such that the aircraft is drivable in the fixed-wing flight mode. The first propulsion unit and the second propulsion unit may be formed by a propeller engine, a rocket propulsion unit, the above described nozzles or a turboprop engine that are driven by fuel, pressurized air or electrical power. The electrical power may be generated by solar power. Moreover, the propulsion units may be formed by a jet engine that is driven by kerosene or hydrogen, for example. If the first propulsion unit is mounted to a first (right) wing and the second propulsion unit is mounted for example to the second (left) wing, both propulsion units may be used to generate thrust and propulsion of the aircraft in the fixed-wing flight mode. The propulsion system may comprise as well a plurality of propulsion units mounted to the wings.

According to a further exemplary embodiment of the aircraft, the first propulsion unit and the second propulsion unit are mounted to the first wing and/or to the second wing such that the first thrust and the second thrust generate a rotation of the first wing and/or the second wing around the longitudinal fuselage axis or the second axis for enabling the hover flight.

According to a further exemplary embodiment, the first propulsion unit and the second propulsion unit are controllable in such a way, that the first thrust and the second thrust are adjustable separately from each other. In particular, if the first propulsion unit is mounted to the first wing and the second propulsion unit is mounted to the second wing and if the first propulsion unit generates the first thrust in a first direction and the second propulsion unit generates a second thrust in a direction that is opposed to the first direction, the rotation of the wings around a longitudinal fuselage axis or the second axis is generatable.

By mounting the propulsion units, e.g. the above described nozzles, to the wings, the rotation of the wings may be generated by a so-called “tip jet”-configuration. Hence, according to such a tip jet-configuration, by mounting the propulsion units and/or nozzles to the wings, the propelling force (thrust) is generated in the wings. In particular, no turning moment (drive torque) have to be transferred from e.g. the fuselage or another central portion of the aircraft to the (tip ends) of the respective wings, which tip ends are generally spaced from the central portion. Hence, no tail rotor is needed to counter the torque effect created by the drive torque of the propulsion devices or units located in the central position.

Moreover, if in one section of the circumference run of the first propulsion unit and the second propulsion unit around the second axis generate less power, a propulsion force is generated that forces the aircraft to drift in a predefined direction. In particular, in order to generate such a drift in the hover flight mode, at one desired section of the circumferential run of the propulsion units around the fuselage, the first propulsion unit and the second propulsion unit may be shut off or reduced every time when a respective propulsion unit passes this desired section, so that less thrust is generated in this predetermined desired section. The term “drift” may denote in the present invention a movement of the aircraft in a substantially horizontal direction that is for example perpendicular to the lifting direction or the vertical direction. Moreover, a drift of the aircraft in the hover flight mode may as well be achieved by changing the angle of the longitudinal wing axis with respect to the longitudinal fuselage axis. For example, if the longitudinal wing axis is perpendicular to the longitudinal fuselage axis, a vertical lift may be achieved. If the longitudinal wing axis comprises an angle other than 90°, a lift may be generated by the rotation of the wings around the fuselage, wherein the direction of the lift comprises a vertical component and a horizontal component, so that depending on the angle between the longitudinal wing axis and the longitudinal fuselage axis a drift and a movement of the aircraft in the hover mode may be achieved.

For example, a position sensor may be provided, wherein the position sensor detects the position of the first propulsion unit and the position of the second propulsion unit. At the desired section of the circumference the sensor sequentially reduces the propulsion power of the respective passing first or second propulsion unit.

According to a further exemplary embodiment, the first propulsion unit and the second propulsion unit are mounted to the first wing and/or to the second wing in such a way that at least one of the first propulsion unit and the second propulsion unit is tiltable, e.g. around the longitudinal wing axis, such that the direction of the first thrust and the direction of the second thrust are adjustable with respect to each other. Hence, the aircraft may be stabilized by the adjustable thrust directions in the hover flight mode or the fixed-wing flight mode and in particular in a status between the hover flight mode and the fixed-wing flight mode. By the adjustment of the first propulsion unit and the second propulsion unit it may also be possible to adjust the rotation of the wings in the hover flight mode and to generate a drift in a horizontal direction in the hover flight mode.

According to a further exemplary embodiment, the aircraft comprises a driving unit, wherein the driving unit is arranged at the aircraft in such a way that a driving torque is applied to the first wing and/or the second wing for rotating the first wing and the second wing around the longitudinal fuselage axis for enabling the hover flight.

The driving units may define motors that do not generate thrust. For example, the driving unit may be an electromotor that drives the wings around the fuselage. For example, the first wing and the second wing may be attached to the bearing ring. The bearing ring may form for example the rotor element of an electromotor. The fuselage may form the stator of the electromotor. Hence, by feeding a respective power to the rotor and/or the stator, a rotation of the bearing ring and thus of the wings around the fuselage is achieved. By using a driving unit for generating the rotation of the wings around the fuselage, weight may be reduced and noise may be reduced as well.

According to a further exemplary embodiment, the aircraft further comprises a control unit for controlling the aircraft in the fixed-wing flight mode and the hover flight mode. The control unit may be controlled for example by a pilot in the aircraft. Moreover, the control unit may be designed for being remote controlled. Hence, the operator of the aircraft may rest on the ground and may control the aircraft by a remote control, for example. Moreover, in a further exemplary embodiment, the control unit is programmable such that the aircraft follows a programmed predetermined flight route (automatically). Hence, an operator may not be necessary, so that the aircraft finds its way alone. In order to provide redundancy system, a plurality of control units might be applicable. Thus, a more robust system is achievable.

For providing a robust remote control system, the aircraft may comprise more than one receiver for receiving the control signals from the operator. For example one receiver may be mounted to the first propulsion unit and the second receiver may be mounted to the second propulsion unit, so that each receiver separately receives the control signal from the operator. Hence, there is no need to provide a central receiver in e.g. the fuselage, which would require long signal lines to the propulsion units and complex control mechanics, for example.

According to a further exemplary embodiment, the aircraft further comprises at least one sensor for measuring a flight parameter of the aircraft and/or an environment parameter of the aircraft, wherein the sensor is connected to the control unit for transferring measured sensor data to the control unit. By measuring the flight parameter and the environment parameter of the aircraft, the aircraft may fly self-acting and may correct for example the flight mechanics self-acting in reaction to changing flight parameters and environment parameters. For example, the aircraft may correct self-acting the flight route, if for example the direction of the wind has been changed. Moreover, the sensor for the environment parameters may comprise a camera, an infrared camera or other recorder devices, so that the aircraft may be used as a reconnaissance aircraft, for example. In particular, the aircraft may be used as a drone.

For providing a smooth change-over from the fixed-wing flight mode to the hover flight mode during the flight of the aircraft, the wing is tilted and the wing (and e.g. the fuselage) begins to rotate around the second axis. During the change-over, the aircraft may flight in a vertical direction until the rotation of the wing is fast enough (for example 200 to 300 rpm) for generating enough lift to prevent the aircraft from stalling. For providing a smooth change-over from the hover flight mode to the fixed-wing flight mode, the rotation of the wing is reduced and the aircraft will be accelerated e.g. by a stall of the aircraft. During the stall the wing is tilted. When reaching a sufficient speed, the wing generates lift by its aerodynamic profile. Instead of accelerating the aircraft by gravity, the propulsion system may accelerate the aircraft for preventing the stall.

According to a further exemplary embodiment, the aircraft comprises a weight stabilizing system. The weight stabilizing device may comprise a weight element that may be moved relatively to the wing and/or the fuselage. Hence, the centre of gravity of the aircraft may be adjusted. For example, the weight element may be moved to a nose section of the fuselage or to the tail section of the fuselage, so that the fuselage may comprise a relative alignment and predetermined tilting angle with respect to the wing. Hence, a desired flight configuration and a proper flight stabilization are achievable. For example, the centre of gravity may be moved during the change between the hover flight mode and the fixed-wing flight mode for stabilizing the aircraft. In particular, the centre of gravity may be adjusted more in the tail section of the fuselage in the hover flight mode, so that the fuselage is generally vertically aligned and the wings comprise a tilted position, in which the rotation around the second axis generates a desired lift. In the fixed-wing flight mode, the centre of gravity is moved more to the nose section of the fuselage in order to achieve a stable flight configuration in the fixed-wing mode, so that the fuselage is generally horizontally aligned and the wings are tilted for generating a desired angle of attack (i.e. the angle between the chord of the wing and the oncoming flow in the fixed-wing mode). Moreover, in order to record the landscape by a camera mounted to the fuselage, it may be possible to align the fuselage to a desired position in order to optimize the alignment of the camera as well.

The aircraft may land and start in the hover flight mode or the fixed-wing flight mode. In the hover flight mode, no runaway is necessary. The aircraft may comprise landing gears mounted e.g. to the fuselage and/or to the wing. The landing gear may comprise a simple static support for supporting the aircraft on the ground without moving the aircraft. Furthermore, the landing gear may comprise wheels, so that the aircraft may be driven on the ground. Hence, a regular start or landing on a runway in the fixed-wing mode is possible. Moreover, the landing gear comprises units for enabling a water start and landing of the aircraft. The units may comprise air cushions or other lifting bodies.

In a further exemplary embodiment, the fuselage comprises a diving tank that is adapter for pouring in water, so that the aircraft may as well be driven under the water. The rotating wing in the hover flight mode may then form a ship propeller for driving the aircraft under the water.

Moreover, according to a further exemplary embodiment, the fuselage and/or the wing comprises a storage room for storing additional load, such as freight or additional equipment.

Moreover, a transmission system is provided, by which fuel, electrical power or data may be transmitted from the wing to the fuselage or vice versa. The fuel and the electrical power may be transmitted mechanically, e.g. by an electrical conductive loop clutch. Data may be transmitted e.g. optically or wirelessly.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered as to be disclosed with this application.

### BRIEF DESCRIPTION OF THE DRAWINGS

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

FIG. 1 illustrates an aircraft according to an exemplary embodiment of the present invention, wherein the aircraft is in the hover flight mode;

FIG. 2 illustrates schematically an aircraft according to the present invention, wherein the aircraft is in the fixed-wing flight mode;

FIG. 3 shows an exemplary embodiment of the aircraft according to an exemplary embodiment of the present invention, wherein a mechanical connection system of the wings and the fuselage is shown;

FIG. 4 shows a schematically view of a tip jet propulsion system of the aircraft according to an exemplary embodiment of the present invention;

FIG. 5 shows the aircraft with the wing in a fixed-wing flight modus according to an exemplary embodiment of the present invention;

FIG. 6 shows the aircraft with the wing in a hover flight modus according to an exemplary embodiment of the present invention; and

FIG. 7 shows an overall view of the aircraft according to an exemplary embodiment of the present invention.

### DETAILED DESCRIPTION

The illustration in the drawings are schematically. It is noted that in different figures, similar or identical elements are provided with the same reference signs.

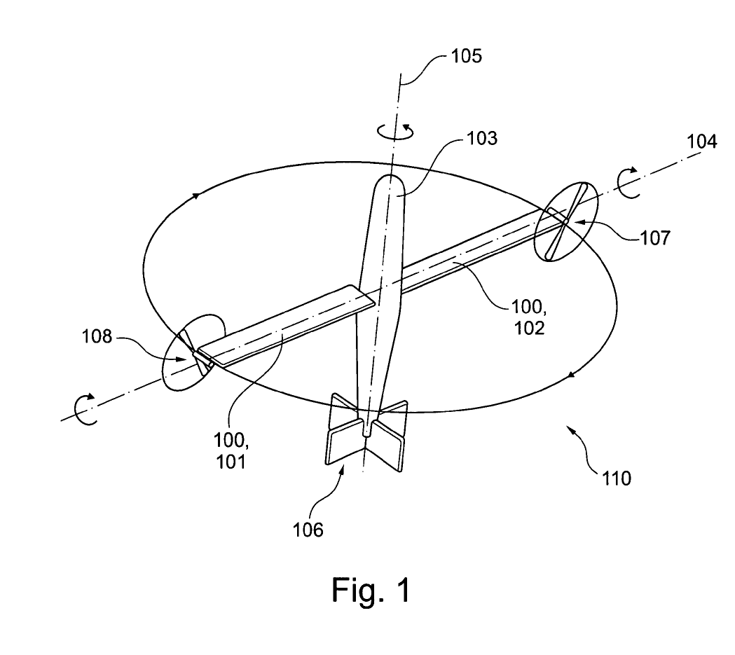

FIG. 1 shows a wing 100 for a vertical take-off and landing vehicle 110. The wing 100 is mountable to a fuselage 103 such that the wing 100 is tiltable around a longitudinal wing axis 104 of the wing 100 and such that the wing 100 is rotatable around a second axis 105 (which may be e.g. the longitudinal fuselage axis 105) that differs to the longitudinal wing axis 104. The wing 100 is adapted in such a way that, in a fixed-wing flight mode, the wing 100 does not rotate around the second axis 105 and wherein the wing 100 is further adapted in such a way that, in a hover flight mode, the wing 100 is tilted around the longitudinal wing axis 104 with respect to its orientation in the fixed-wing flight mode and that the wing 100 rotates around the second axis 105.

In particular, FIG. 1 shows an aircraft 110 for vertical take-off and landing in the hover flight mode. In the exemplary embodiment of FIG. 1 the wing 100 comprises a first (left) wing 101 and a second (right) wing 102. The first wing 101 comprises a longitudinal wing axis and the second wing 102 comprises a second longitudinal wing axis. In the hover flight mode shown in FIG. 1, the first wing longitudinal axis and the second longitudinal wing axis run parallel to the longitudinal wing axis 104. In other words, the first wing 101 and the second wing 102 form a rotor, such as a helicopter rotor, in the hover flight mode. The first wing 101 extends along the first longitudinal wing axis and the second wing 102 extends along the second longitudinal wing axis from the fuselage 103. The first wing 101 is tiltable with a first rotational direction around the first longitudinal wing axis 104 and the second wing 102 is tiltable with a second rotational direction around the second longitudinal wing axis 104.

The tilting of the first wing 101 and the second wing 102 around its respective longitudinal wing axis 104 is indicated by the arrow around the longitudinal wing axis 104. Moreover, in FIG. 1 it is shown that the first wing 101 and the second wing 102 comprise a respective leading edge, wherein the leading edge is oriented in the rotating direction of the wings 101, 102 in contrary to the trailing edge. The circumferential movement (rotating direction) of the wings 100, 101, 102 is indicated by the arrows 15 in FIG. 1.

In order to generate lift in the hover flight mode, the wings 100, 101, 102 may rotate together with the fuselage 103 around the second axis 105 or independently of the fuselage 103. Then, the fuselage 103 may 20 comprise no or a lower rotational speed in comparison to the wings 100, 101, 102.

Moreover, in FIG. 1 a first propulsion unit 107 is mounted close to the tip end of the first wing 101 and a second propulsion unit 108 is mounted to a tip end section of the second wing 102. In the exemplary embodiment of FIG. 1 the propulsion units 107, 108 are propellers. In other exemplary embodiments, for example jet engines or turboprop engines may be applied as well. As shown in FIG. 1, the propellers of the propulsion units 107, 108 generate thrust, wherein the first thrust direction of the first propulsion unit 107 runs in a counter-direction with respect to the second thrust direction that is generated by the second propulsion unit 108.

Hence, a torque is generated that causes the wings 101, 102 to rotate around the second axis 105, e.g. the longitudinal fuselage axis 105 of the fuselage 103. The rotation speed may be approximately around 200 to 300 rpm (rounds per minute) to generate a lift for lifting the aircraft 110 in the hover flight mode.

Moreover, FIG. 1 shows the fuselage 103 that comprises an empennage 106 with e.g. four control surfaces. The empennage 106 may balance the fuselage 110 in the hover flight mode and/or the fixed-wing flight mode. Moreover, the empennage 106 may control the flight direction of the aircraft 110. In an exemplary embodiment, the empennage 106 may rotate around the longitudinal fuselage axis 105. This rotation of the empennage 106 may cause a torque that acts against the torque that is induced to the fuselage 103 by the rotation of the wings 101, 102.

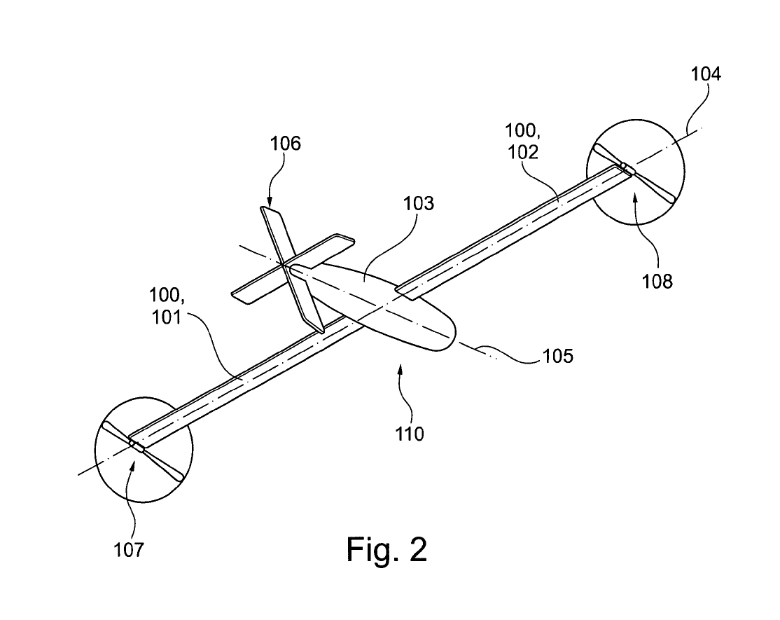

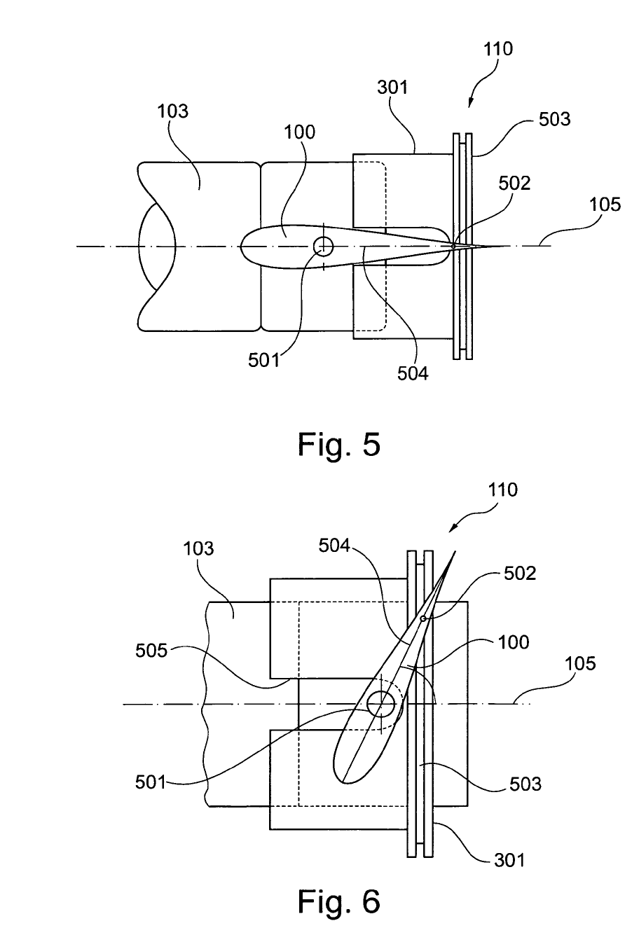

FIG. 2 shows the aircraft 110 in a fixed-wing flight mode. In the fixed-wing flight mode, the first wing 101 and the second wing 102 are tilted around the longitudinal wing axis 104 in such a way, that for example the respective chord line 504 (see FIG. 5) of the first wing 101 and the chord line 504 of the second wing 102 run e.g. substantially parallel to the longitudinal fuselage axis 105 of the fuselage 103. The first propulsion unit 107 and the second propulsion unit 108 are tilted also in comparison to the hover flight mode shown in FIG. 1 around the respective first wing 101 or the respective second wing 102. The first propulsion unit 107 and the second propulsion unit 108 are also tiltable independently from the wings 101, 102. In the fixed-wing flight mode, the first propulsion unit 107 generates a first thrust and the second propulsion unit 108 generates a second thrust, wherein the first thrust and the second thrust are generally directed parallel to each other. Hence, propulsion for driving the aircraft 100 is generated. In this fixed-wing flight mode, the aircraft 110 flights through the air more efficiently in comparison to the drift or movement in the hover flight mode. The empennage 106 is used for controlling the flight direction of the aircraft 110.

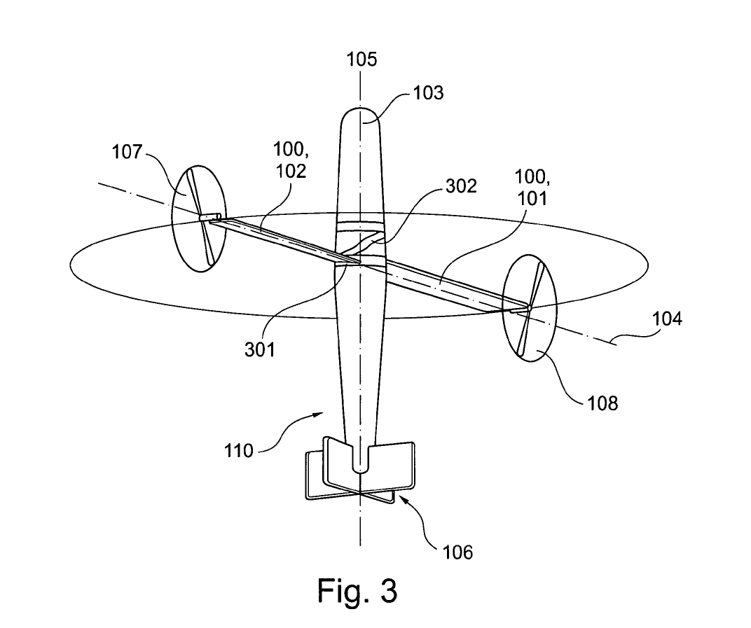

FIG. 3 shows the aircraft 110 in the hover flight mode. The first wing 101 and the second wing 102 are each mounted to a bearing ring 301. The bearing ring 301 may envelope the surface of the fuselage 103. Hence, it is not necessary to provide a run of the wings 100, 101, 102 through the fuselage 103, which may cause problems and demands complex mechanical solutions due to the rotation of the wing 100, 101, 102 with respect to the fuselage 103. The bearing ring 301 may clamp the wing 100, 101, 102 to the surface of the fuselage 103. Hence, a light and robust fixation of the wings 100, 101, 102 to the fuselage 103 is achievable.

Moreover, a mechanical system for tilting the wing 100 between the hover flight mode and the fixed-wing flight mode may be generated. To the front end of the wing 100 at the root end of the wing 100 two bolts, namely a first bolt 501 (see FIG. 5) and a second bolt 502 (see FIG. 5) may be mounted. Each bolt 501, 502 extend from the front end in the direction of the fuselage 103. The first bolt 501 may be rotatably mounted to the fuselage 103 and the second bolt 502 may be rotatably mounted to the bearing ring 301. The first bolt 501 may be fixed to the fuselage 103 in such a way that a guiding slot 302 of the fuselage 103 envelops the first bolt 501. The run of the guiding slot 302 may describe a desired run of the first bolt 501 during the movement of the wings 100, 101, 102 between the hover flight mode and the fixed-wing flight mode.

If the bearing ring 301 is moved slideably along the fuselage 103, the first bolt 501 moves along the run of the guiding slot 302. The guiding slot 302 determines a defined movement of the first bolt 501 during the movement of the bearing ring 301 along the fuselage 103. When moving the bearing ring 301 along the fuselage 103, the first bolt 501 moves inside the guiding slot 302, so that the wings 100, 101, 102 tilt to the desired position. Hence, the run of the guiding slot 302 defines the tilting movement of the respective wings 100, 101, 102.

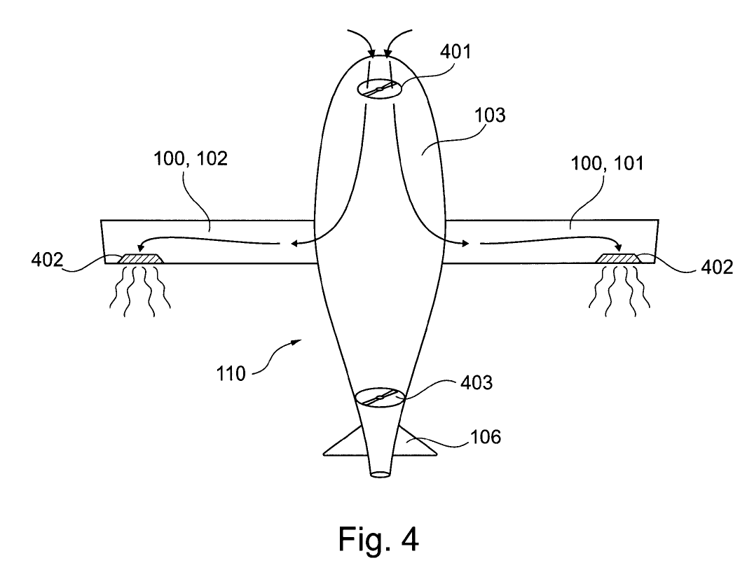

FIG. 4 illustrates schematically the aircraft 110 in the fixed-wing flight mode. Moreover, a tip jet propulsion system for the aircraft 110 is shown.

In the nose section of the fuselage 103, an air inlet may is formed, wherein an air suction unit 401 sucks in air inside the fuselage 103. An air distribution system may guide the sucked in air to nozzle sections 402 that are located in the trailing edge of the wings 100, 101, 102. The nozzle sections 402 blow the sucked in air out to the environment, so that thrust is generated. By the generated thrust, propulsion of the aircraft 110 is generated. When tilting the wing 100 in the hover flight mode, the nozzle section 402 of the right wing 101 and the nozzle section 402 of the left wing 102 may generate a thrust in opposite direction, so that a rotation of the wing 100, 101, 102 around the fuselage is achieved.

Additionally or alternatively, in the tail of the fuselage 103 a fuselage propulsion unit 403 may be installed. The fuselage propulsion unit 403 may be for example a jet engine, a turboprop engine or a propeller engine. In the tail section of the fuselage 103 the empennage 106 is shown, so that the aircraft 110 is controllable.

FIG. 5 and FIG. 6 illustrate an adaption mechanism of the aircraft 110 for tilting the wing 100 with respect to the fuselage 103. FIG. 5 shows an aircraft configuration in the fixed-wing mode, wherein the chord line 504 of the wing 100 is generally parallel to the second axis 105, e.g. the longitudinal fuselage axis. FIG. 6 shows an aircraft configuration in the hover flight mode, wherein the chord line 504 comprises an angle of approximately 60° to 120° with respect to the second axis 105.

As shown in FIG. 5, the first bolt 501 pivotably fixes the wing 100 to the fuselage 103, wherein, in the exemplary embodiment of FIG. 5, the first bolt 501 is in not laterally movable with respect to the fuselage 103. As shown in the embodiment shown in FIG. 3, the first bolt 501 may alternatively or additionally be slidable engaged by a guiding slot 302 of the fuselage 103. The second bolt 502 fixes the wing 100 to the bearing ring 301. Thereby, the bearing ring 301 may comprise a ring-shaped element with a further guiding slot 503, to which the second bolt 502 is slidably engaged.

When moving the bearing ring 301 along the fuselage 103, the wing 100 rotates around the first bolt 501 and the second bolt 502, wherein the second bolt 502 additionally slides along the further guiding slot 503 generally in a direction perpendicular to the second axis 105. For this reason, the wing conducts a rotation with a rotating axis that corresponds to the rotating axis of the first bolt 501 until the desired position of the wing 100 is reached.

Edges of the further guiding slot 503 limit a relative motion of the second bolt 502 in further guiding slot 503, so that the relative motion of the bearing ring 301 with respect to the fuselage 103 is limited as well. Thus, the length of the further guiding slot 503 defines a length of motion of the bearing ring 301 with respect to the fuselage 103, so that as well a defined rotation and defined start and end positions of the wing 100 with respect to the fuselage 103 are adjustable.

Furthermore, the bearing ring 301 comprises a guide groove 505 which has a run in general parallel to the movement of the bearing ring 301 along the fuselage 103. The guide groove 505 engages the first bolt 501. If the bearing ring 301 has moved along the fuselage to the direction of the first bolt 501, the edges of the guide groove 505 limit a further motion of the bearing ring 301 along the fuselage 103, so that a further rotation of the wing 100 is limited as well. Hence, the dimensions of the guide groove 505 delimit the tilting angle of the wing 100.

FIG. 6 shows the aircraft 110 in the hover flight mode. The wing 100 is tilted in such a way that by the rotation of the wing 100 and e.g. the bearing ring 301 around the second axis 105, a lift is generated. In particular, the chord line 504 comprises a tilting angle to the second axis 105 of approximately 60° to 120°.

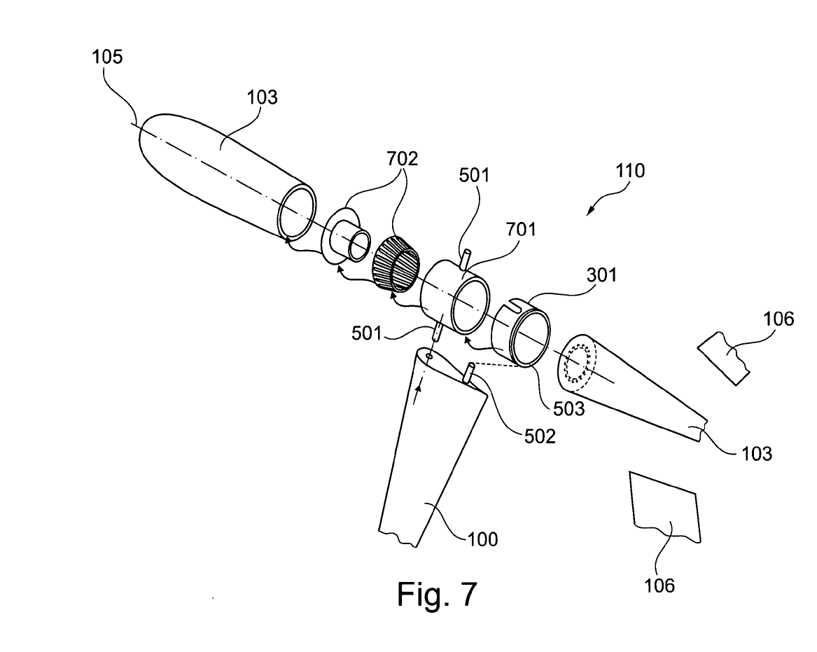

FIG. 7 shows an overall view of the aircraft 110 as shown in FIG. 5 and FIG. 6. The fuselage 103 comprises coupling elements 702 to which the wing 100, the bearing ring 301 and/or a fuselage ring 701 is coupled. The bearing ring 301 may be mountable to the fuselage ring 701 (supporting ring). The fuselage ring 701 is rotatably connectable to the fuselage 103. The first bolt 501 is fixed to the fuselage ring 701. The fuselage ring 701 is in particular rotatable around the coupling elements 702.

Moreover, it is outlined that the wing 100 may comprise the first wing 101 and the second wing 102 that are mounted e.g. to the fuselage ring 701 by respective first bolts 501 and that are mounted e.g. to the bearing ring 301 by respective second bolts 502. As indicated in FIG. 5 and FIG. 6, the first wing 101 may rotate clockwise according to a direction of movement of the bearing ring 301 along the second axis 105. The second wing 102, which extends in opposite direction from the fuselage 103 with respect to the first wing 101, may rotate counterclockwise according to the direction of movement of the bearing ring 301 along the second axis 105 or vice-versa. In other words, the second bolt 502, to which the first wing 101 is mounted, is movable along a first direction inside the further guiding slot 503 and a further second bolt 502, to which the second wing 102 is mounted, is movable along a second direction inside the further guiding slot 503.

Moreover, as shown in FIG. 7, the empennage 106 is fixed to a tail section of the fuselage 103.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

### LIST OF REFERENCE SIGNS

100 wing
101 first wing
102 second wing
103 fuselage
104 longitudinal wing axis
105 longitudinal fuselage axis, second axis
106 empennage
107 first propulsion unit
108 second propulsion unit
110 aircraft
301 bearing ring
302 guiding slot
401 air suction unit
402 nozzle section
403 fuselage propulsion unit
501 first bolt
502 second bolt
503 further guiding slot
504 chord line
505 guide groove
701 supporting ring
702 coupling element

1. Wing for a vertical take-off and landing aircraft,
wherein the wing is mountable to a fuselage such that the wing is tiltable around a longitudinal wing axis of the wing and such that the wing is rotatable around a second axis that differs to the longitudinal wing axis,
wherein the wing is adapted in such a way that, in a fixed-wing flight mode, the wing does not rotate around the second axis, and
wherein the wing is further adapted in such a way that, in a hover flight mode, the wing is tilted around the longitudinal wing axis with respect to its orientation in the fixed-wing flight mode and that the wing rotates around the second axis.

2. Wing according to claim 1,
wherein the wing comprises a bearing ring,
wherein the bearing ring is formed for being clamped to a surface of the fuselage for mounting the wing to the fuselage.

3. Wing according to claim 2,
wherein the bearing ring is slideably mountable to the fuselage for being slideable along the surface of the fuselage in the direction of the second axis,
wherein the wing comprises a first bolt and a second bolt, and
wherein the wing is mountable to the fuselage by the first bolt and the wing is mounted to the bearing ring by the second bolt such that by a predetermined movement of the bearing ring along the second axis the wing is tiltable between the fixed-wing flight mode and the hover flight mode.

4. (canceled)

5. Aircraft according to claim 4,
wherein a bearing ring of the wing is slideably mounted to the fuselage for being slideable along the surface of the fuselage in the direction of a longitudinal fuselage axis,
wherein the first bolt is connected to the fuselage for mounting the wing to the fuselage, and
wherein the fuselage is adapted for holding the bearing ring to which the wing is mounted with the second bolt.

6. Aircraft according to claim 4,
wherein the fuselage comprises an empennage for controlling the flight direction in the fixed-wing flight mode and the hover flight mode.

7. Aircraft according to claim 6,
wherein the empennage is rotatably mounted to the fuselage such that the empennage is rotatable around the longitudinal fuselage axis in the hover flight modus for reducing a torque that is induced by the rotating wing in the fuselage.

8. (canceled)

9. Aircraft according to claim 4,
wherein the first rotational direction differs to the second rotational direction.

10. Aircraft according to claim 4, further comprising:
a propulsion system for generating thrust such that the aircraft is driven in the fixed-wing flight mode and/or the hover flight mode.

11. Aircraft according to claim 10,
wherein the propulsion system is mounted to the fuselage.

12. (canceled)

13. Aircraft according to claim 10, further comprising:
an air distribution system mounted inside the fuselage and inside the first wing and/or the second wing,
wherein the first wing and/or the second wing comprises at least a nozzle section for blowing out air such that thrust is generatable,
wherein the propulsion system comprises an air suction unit that is mounted to the aircraft such that air is sucked inside the fuselage and fed to the air distribution system,
wherein the air distribution system is arranged inside the first wing and/or the second wing such that fed air is guided to the nozzle section.

14. Aircraft according to claim 13,
wherein the first wing and/or the second wing comprises a plurality of nozzle sections connected to the air distribution system for blowing out air such that thrust is generatable.

15. Aircraft according to claim 14,
wherein each of the plurality of nozzle sections is controllable in such a way that the thrust generatable by each of the plurality of nozzle sections is adjustable individually.

16. Aircraft according to claim 10,
wherein the propulsion system comprises a first propulsion unit mounted to the first wing for generating first thrust and a second propulsion unit mounted to the second wing for generating second thrust such that the aircraft is drivable in the fixed-wing flight.

17. Aircraft according to claim 16,
wherein the first propulsion unit and the second propulsion unit are mounted to the first wing and/or the second wing such that the first thrust and the second thrust generate a rotation of the first wing and/or the second wing around the second axis for enabling the hover flight.

18. Aircraft according to claim 16,
wherein the first propulsion unit and the second propulsion unit are controllable in such a way that the first thrust and the second thrust are adjustable separately from each other.

19. Aircraft according to claim 16,
wherein the first propulsion unit and the second propulsion unit are mounted to the first wing and/or the second wing in such a way that at least one of the first propulsion unit and the second propulsion unit is tiltable such that the direction of the first thrust and the direction of the second thrust are adjustable with respect to each other.

20. Aircraft according to claim 4, further comprising:
a driving unit,
wherein the driving unit is arranged at the aircraft in such a way that a driving torque is applied to the first wing and/or the second wing for rotating the first wing and the second wing around the second axis for enabling the hover flight.

21. Aircraft according to claim 4, further comprising:
a control unit for controlling the aircraft in the fixed-wing flight mode and the hover flight mode.

22.-24. (canceled)

25. Method of controlling an aircraft for vertical take-off and landing, the method comprising:
converting the aircraft in a fixed-wing flight mode by arranging the wing and the fuselage with respect to each other such that a fixed-wing flight is enabled, and
converting the aircraft in a hover flight mode by tilting the wing around a longitudinal wing axis and by rotating the wing around a second axis for enabling a hover flight.

26. (canceled)

27. Aircraft for vertical take-off and landing, the aircraft comprising:
a first wing according to claim 1,
a second wing according to claim 1, and
a fuselage which is adapted in such a way that the first wing and the second wing are mountable to the fuselage,
wherein the first wing comprises a first longitudinal wing axis and the second wing comprises a second longitudinal wing axis, wherein the first wing extends along the first longitudinal wing axis and the second wing extends along the second longitudinal wing axis from the fuselage,
wherein the first wing is tiltable with a first rotational direction around the first longitudinal wing axis, and
wherein the second wing is tiltable with a second rotational direction around the second longitudinal wing axis.
